(19) United States
(12) Patent Application Publication
(10) Pub. No.: US 2025/0218074 A1
(43) Pub. Date: Jul. 3, 2025

(54) METHOD AND ELECTRONIC DEVICE FOR CREATING CONTINUITY IN A STORY

(71) Applicant: SAMSUNG ELECTRONICS CO., LTD., Suwon-si (KR)

(72) Inventors: Sukumar MOHARANA, Bengaluru (IN); Dwaraka Bhamidipati SREEVATSA, Bengaluru (IN); Debi Prasanna MOHANTY, Bengaluru (IN); Siva Prasad THOTA, Bengaluru (IN); Gopi RAMENA, Bengaluru (IN)

(73) Assignee: SAMSUNG ELECTRONICS CO., LTD., Suwon-si (KR)

(21) Appl. No.: 19/087,109

(22) Filed: Mar. 21, 2025

Related U.S. Application Data
(63) Continuation of application No. PCT/KR2023/005716, filed on Apr. 27, 2023.

(30) Foreign Application Priority Data
Sep. 21, 2022 (IN) 202241054004
Dec. 2, 2022 (IN) 202241054004

(51) Int. Cl. G06T 11/20; G06F 40/166; G06T 7/246; G06V 10/44; G06V 10/74; G06V 20/50

(52) U.S. Cl. CPC G06T 11/206; G06F 40/166; G06T 7/248; G06V 10/44; G06V 10/761; G06V 20/50; G06T 2207/30241

(57) ABSTRACT

A method for creating continuity in digital content, the method including: determining a plurality of parameters associated with at least one first image; determining a plurality of parameters associated with at least one second image; generating a graphical representation to connect the at least one first image with the at least one second image based on the plurality of parameters associated with the at least one first image and the plurality of parameters associated with the at least one second image; and displaying the digital content comprising the at least one first image, the at least one second image, and the generated graphical representation between the at least one first image and the at least one second image.

### CROSS-REFERENCE TO RELATED APPLICATIONS

This application is a continuation of International Application No. PCT/KR2023/005716, filed on Apr. 27, 2023, which claims priority to Indian Patent Application No. 202241054004, filed on Dec. 2, 2022, and claims priority to Indian Patent Application No. 202241054004, filed on Sep. 21, 2022, in the Indian Patent Office, the disclosures of each of which are incorporated by reference herein their entirety.

### BACKGROUND

### 1. Field

The present disclosure relates to electronic devices, and more particularly, to a method and an electronic device for creating continuity in a story.

### 2. Description of Related Art

In general, photo story makes sharing of photos and videos with friends and family easier. In the related art, the photos are grouped into the photo story based on the analysis of metadata associated with the photos by selecting a set of images based on a predefined policy. Further, multiple personalized storylines are generated from a given set of photos. Related art systems and methods perform automatic theme-related keyword extraction from user's natural language comments on the photos and videos. In one or more examples, ‘theme’ indicates the concepts circumscribing and describing content of the photos and videos such as pets, natural sites, palaces and places and the like.

The related art systems and methods do not make an understanding of the theme of the story, and estimate the pictograph of each photo with respect to the theme of the story. Further, estimation of the pictograph of each photo with respect to the theme of the story is important for creating continuity in the photo story.

The related art methods and systems create, manage and share photo stories by selecting the set of photo story design templates for each of the different photo stories based on the analysis of the photos and the metadata associated with the photos grouped into different photo stories. However, the related art methods and systems focus on the grouping of photos into stories based on the analysis of the metadata associated with the photos, but do not predict a bridge event between the photos in the story and complete the story visualization by adding the generated scenes between the photos complying with the theme of the story.

Thus, it is desired to address the above mentioned disadvantages or other shortcomings or at least provide a useful alternative.

### SUMMARY

According to an aspect of the disclosure, a method for creating continuity in digital content, the method including: determining a plurality of parameters associated with at least one first image; determining a plurality of parameters associated with at least one second image; generating a graphical representation to connect the at least one first image with the at least one second image based on the plurality of parameters associated with the at least one first image and the plurality of parameters associated with the at least one second image; and displaying the digital content including the at least one first image, the at least one second image, and the generated graphical representation between the at least one first image and the at least one second image.

The plurality of parameters associated with the at least one first image includes one or more scene elements in the at least one first image, one or more actions of the one or more scene elements in the at least one first image, and a theme formed by the one or more scene elements in the at least one first image, and wherein the plurality of parameters associated with the at least one second image includes one or more scene elements in the at least one second image, one or more actions of the one or more scene elements in the at least one second image, and a theme formed by the one or more scene elements in the at least one second image.

The generating the graphical representation to connect the at least one first image with the at least one second image includes: predicting at least one bridge event that connects the at least one first image with the at least one second image based on the plurality of parameters associated with the at least one first image and the plurality of parameters associated with the at least one second image; and generating a graphical representation of the bridge event to connect the at least one first image with the at least one second image.

The predicting the at least one bridge event that connects the at least one first image with the at least one second image includes: creating a first textual summary for the at least one first image based on the plurality of parameters associated with the at least one first image; creating a second textual summary for the at least one second image based on the plurality of parameters associated with the at least one second image; generating, at least one first pictograph for the at least one first image based on the first textual summary created for the at least one first image; generating at least one second pictograph for the at least one second image based on the second textual summary created for the at least one second image; and predicting at least one bridge event for connecting the at least one first image and the at least one second image based on the at least one first pictograph generated for the at least one first image and the at least one second pictograph generated for the at least one second image.

The generating the graphical representation of the bridge event to connect the at least one first image with the at least one second image includes: comparing the at least one first image and the at least one second image based on the theme formed by the one or more scene elements in the at least one first image and the theme formed by the one or more scene elements in the at least one second image; determining whether an image relationship distance between the at least one first image and the at least one second image is less than a first threshold based on the comparison between the at least one first image and the at least one second image; and based on determining that the image relationship distance between the at least one first image and the at least one second image is less than the first threshold, generating the graphical representation of the bridge event to connect the at least one first image with the at least one second image.

The method further includes obtaining a plurality of images that include the at least one first image and the at least one second image; identifying one or more features of an object available in each image of the plurality of images; determining a similarity score for grouping images of the plurality of images having features of the object with a different less than a threshold into a span; generating multiple spans for the plurality of images based on the similarity score between the images of the plurality of images; determining a visual scene distance between the multiple spans of the plurality of images; determining whether the visual scene distance between the multiple spans of the plurality of images is less than a second threshold; and based on determining that the visual scene distance between the multiple spans of the plurality of images is less than the second threshold, generating the graphical representation of the bridge event to connect the multiple spans of the plurality of images.

The generating the multiple spans for the plurality of images based on the similarity score between the images of the plurality of images includes: determining a trajectory of the object available in the at least one first image of the plurality of images and the trajectory of the object available in the at least one second image of the plurality of images; identifying the features of the object available in the at least one first image and the features of the object available in the at least one second image of the plurality of images based on the determined trajectories of the objects available in the at least one first image and in the at least one second image of the plurality of images; determining whether the similarity score between the at least one first image of the plurality of images and the at least one second image of the plurality of images is higher than a third threshold based on the identified features of the objects available in the at least one first image and in the at least one second image of the plurality of images; and generating the multiple spans for the plurality of images based on the similarity score between the at least one first image of the plurality of images and the at least one second image of the plurality of images.

According to an aspect of the disclosure, an electronic device for creating continuity in digital content, the electronic device includes: a memory storing one or more instructions; communication circuitry; a processor operatively coupled to the communication circuitry and the memory and configured to execute the one or more instructions in the memory, wherein the one or more instructions, when executed by the processor, cause the electronic device to: determine a plurality of parameters associated with at least one first image, determine a plurality of parameters associated with at least one second image, generate a graphical representation to connect the at least one first image with the at least one second image based on the plurality of parameters associated with the at least one first image and the plurality of parameters associated with the at least one second image, and display the digital content including the at least one first image, the at least one second image, and the generated graphical representation between the at least one first image and the at least one second image.

The plurality of parameters associated with the at least one first image includes one or more scene elements in the at least one first image, one or more actions of the one or more scene elements in the at least one first image, and a theme formed by the one or more scene elements in the at least one first image, and wherein the plurality of parameters associated with the at least one second image comprises one or more scene elements in the at least one second image, one or more actions of the one or more scene elements in the at least one second image, and a theme formed by the one or more scene elements in the at least one second image.

The one or more instructions, when executed by the processor, cause the electronic device to: predict at least one bridge event that connects the at least one first image with the at least one second image based on the plurality of parameters associated with the at least one first image and the plurality of parameters associated with the at least one second image, and generate a graphical representation of the bridge event to connect the at least one first image with the at least one second image.

The one or more instructions, when executed by the processor, cause the electronic device to: create a first textual summary for the at least one first image based on the plurality of parameters associated with the at least one first image, create a second textual summary for the at least one second image based on the plurality of parameters associated with the at least one second image; generate at least one first pictograph for the at least one first image based on the first textual summary created for the at least one first image; generate at least one second pictograph for the at least one second image based on the second textual summary created for the at least one second image; and predict at least one bridge event for connecting the at least one first image and the at least one second image based on the at least one first pictograph generated for the at least one first image and the at least one second pictograph generated for the at least one second image.

The one or more instructions, when executed by the processor, cause the electronic device to: compare the at least one first image and the at least one second image based on the theme formed by the one or more scene elements in the at least one first image and the theme formed by the one or more scene elements in the at least one second image; determine whether an image relationship distance between the at least one first image and the at least one second image is less than a first threshold based on the comparison between the at least one first image and the at least one second image; and based on determining that the image relationship distance between the at least one first image and the at least one second image is less than the first threshold, generate the graphical representation of the bridge event to connect the at least one first image with the at least one second image.

The one or more instructions, when executed by the processor, cause the electronic device to: obtain a plurality of images that include the at least one first image and the at least one second image; identify one or more features of an object available in each image of the plurality of images; determine a similarity score for grouping images of the plurality of images having features of the object with a different less than a threshold into a span; generate multiple spans for the plurality of images based on the similarity score between the images of the plurality of images; determine a visual scene distance between the multiple spans of the plurality of images; determine whether the visual scene distance between the multiple spans of the plurality of images is less than a second threshold; and based on determining that the visual scene distance between the multiple spans of the plurality of images is less than the second threshold, generate the graphical representation of the bridge event to connect the multiple spans of the plurality of images.

The one or more instructions, when executed by the processor, cause the electronic device to: determine a trajectory of the object available in the at least one first image of the plurality of images and the trajectory of the object available in the at least one second image of the plurality of images; identify the features of the object available in the at least one first image and the features of the object available in the at least one second image of the plurality of images based on the determined trajectories of the objects available in the at least one first image and in the at least one second image of the plurality of images; determine the similarity score between the at least one first image of the plurality of images and the at least one second image of the plurality of images is higher than a third threshold based on the identified features of the objects available in the at least one first image and in the at least one second image of the plurality of images; and generate the multiple spans for the plurality of images based on the similarity score between the at least one first image of the plurality of images and the at least one second image of the plurality of images.

According to an aspect of the disclosure, a non-transitory computer readable medium having instructions stored therein, which when executed by a processor, cause the processor of an electronic device to perform a method for creating continuity in digital content, the method including: determining a plurality of parameters associated with at least one first mage; determining a plurality of parameters associated with at least one second image; generating a graphical representation to connect the at least one first image with the at least one second image based on the plurality of parameters associated with the at least one first image and the plurality of parameters associated with the at least one second image; and displaying the digital content including the at least one first image, the at least one second image, and the generated graphical representation between the at least one first image and the at least one second image.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the embodiments thereof, and the embodiments herein include all such modifications.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an electronic device for creating continuity in a story, according to one or more embodiments;

FIG. 2 is a flow chart illustrating a method for creating continuity in the story by the electronic device, according to one or more embodiments;

FIG. 3 is a block diagram of the system for creating continuity in the story, according to one or more embodiments;

FIG. 4 is an example illustrating the images with gap to be bridged to bring continuity in the story, according to the related art;

FIG. 5A and 5B are examples illustrating the process for bridging the gap between two images, according to one or more embodiments;

FIG. 6 is an example illustrating story visualization based on a scene distance, according to one or more embodiments;

FIG. 7 is a block diagram illustrating multi-image story summarization, according to one or more embodiments; and

FIG. 8 is a block diagram illustrating the process of creating story based text summary for individual images, according to one or more embodiments.

### DETAILED DESCRIPTION

The embodiments of the present disclosure are directed to a method and an electronic device for creating continuity in a story. The method includes determining scene elements in two or more images, actions of the scene elements in the two or more image, and a theme formed by the scene elements in the two or more image, and predicting a bridge event that connects the theme of the two or more images.

The embodiments of the present disclosure generate a graphical representation of the bridge event to connect the two or more images based on the theme of the two or more images to create continuity in the story.

Therefore, the proposed method creates the story from the two or more images in which the graphical representation of the bridge event created from the two or more images is inserted between the two or more images to bridge a gap between the two or more images with respect to one or more of an action, an event, characters and a scene. Thereby, enhancing a story viewing experience for a user, by creating continuity in the story.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein disclose a method for creating continuity in a story by an electronic device. The method includes, for example, receiving a first image and a second image as an input. The method includes determining a plurality of parameters associated with the first image and the plurality of parameters associated with the second image. In one or more examples, the plurality of parameters include scene elements in the first image and the second image, actions of the scene elements in the first image and the second image, and a theme formed by the scene elements in the first image and the second image. The method also includes generating a graphical representation to connect the first image with the second image based on the plurality of parameters associated with the first image and the plurality of parameters associated with the second image. Further, the method includes displaying a story comprising the first image, the second image, and the generated graphical representation between the first image and the second image.

Accordingly, the embodiments herein disclose an electronic device for creating continuity in a story. In one or more examples, the electronic device includes a memory, a processor coupled to the memory, a communicator coupled to the memory and the processor, and a story management controller coupled to the memory, the processor and the communicator. The story management controller is configured to receive a first image and a second image as an input, and determine a plurality of parameters associated with the first image and the plurality of parameters associated with the second image. The plurality of parameters includes scene elements in the first image and the second image, actions of the scene elements in the first image and the second image, and a theme formed by the scene elements in the first image and the second image. The story management controller also generates a graphical representation to connect the first image with the second image based on the plurality of parameters associated with the first image and the plurality of parameters associated with the second image. Further, the story management controller displays a story comprising the first image, the second image, and the generated graphical representation between the first image and the second image.

Related art methods and systems create, manage and share photo stories. The method receives photos and metadata associated with the photos from a user. The photos and the metadata associated with the photos are analyzed, and the photos are responsively grouped into a plurality of different photo stories based on the analysis of the photos and the metadata associated with the photos. The set of photo story design templates for each of the different photo stories are selected based on the analysis of the photos and the metadata associated with the photos grouped into the different photo stories. However, the related art methods and systems focus on the grouping of photos into stories based on the analysis of the metadata associated with the photos, but does not predict the bridge event between the photos in the story and complete the story visualization by adding generated scenes between the photos complying with the theme of the story.

Related art methods and systems perform theme related keyword extraction from comments provided on the photos. In one or more examples, the theme is extracted from the photos and videos and the related keywords are extracted from the comments provided on these content. However, the related art methods and systems do not make an understanding of the theme of the story, and generate theme understanding on the story. Moreover, the related art methods and systems do not estimate the pictograph of each photo with respect to the theme of the story to generate the bridge event to connect the images in the story.

Unlike to the related art methods and systems, the embodiments of the present disclosure predict a bridge event to connect a theme of two or more images, and generate the graphical representation of the bridge event to connect the two or more images based on the theme of the two or more images. Further, the embodiments of the present disclosure display the story including the first image, the second image, and the generated graphical representation between the first image and the second image to create continuity in the story. Thereby, bridging the gap between the first image and the second image with respect to one or more of an action, an event, characters and a scene, and enhancing a user experience of story viewing, by creating continuity in the story. In one or more examples, the two images may be temporally related where one image occurs before another image.

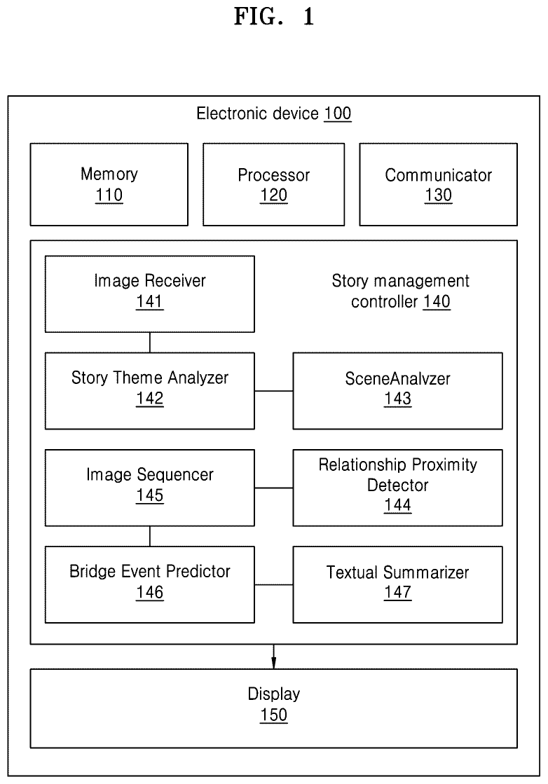

Referring now to the drawings and more particularly to FIGS. 1 through 8, where similar reference characters denote corresponding features consistently throughout the figure, these are shown preferred embodiments.

FIG. 1 is a block diagram of the electronic device 100 for creating continuity in the story, according to one or more embodiments. Referring to the FIG. 1, the electronic device 100 may be but not limited to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system.

In one or more embodiments, the electronic device 100 includes a memory 110, a processor 120, a communicator 130, a story management controller 140 and a display 150.

The memory 110 is configured to store multiple images received as an input. The memory 110 can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 is configured to store larger amounts of information. In certain examples, a non-transitory storage medium may store data that can, over time, change (e.g., in Random Access Memory (RAM)).

The processor 120 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 120 may include multiple cores and is configured to analyze the stored multiple images in the memory 110.

The processor (120) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor (120) may include a combination of processors performing various of the recited/disclosed functions, e.g., in a distributed manner. At least one processor may execute program instructions to achieve or perform various functions.

In one or more embodiments, the communicator 130 includes an electronic circuit specific to a standard that enables wired or wireless communication. The communicator 130 is configured to communicate internally between internal hardware components of the electronic device 100 and with external devices via one or more networks. In one or more examples, the communicator 130 may be referred to as communication circuitry.

In one or more embodiments, the story management controller 140 includes an image receiver 141, a story theme analyzer 142, a scene analyzer 143, a relationship proximity detector 144, an image sequencer 145, a bridge event predictor 146 and a textual summarizer 147.

In one or more embodiments, an image receiver 141 of the story management controller 140 is configured to receive images of the story as an input.

In one or more embodiments, the story theme analyzer 142 of the story management controller 140 is configured to determine the parameters associated with the images. The parameters may include, but are not limited to, scene elements such as, for example, a player, a fitness trainer/trainee in the images, actions, and a theme formed by the scene elements in the images. In one or more examples, the actions may correspond to an action of a scene element such as playing, fitness training, etc. In one or more examples, the theme may include a game, a fitness journey, birthday celebration, travel trip formed by the scene elements in the images. The story theme analyzer 142 may be configured to summarize the overall story into a textual format based on the determination of the parameters associated with the images.

In one or more embodiments, the scene analyzer 143 may be configured to analyze and predict the scenes connecting one image with another image based on the parameters associated with the images.

In one or more embodiments, the relationship proximity detector 144 may be configured to detect a relationship proximity distance between the consecutive images including objects such as, for example, a ball, a net, fitness tools, buildings, animals, vehicles, etc., The relationship proximity distance may refer to “an image relationship distance”, “a visual scene distance” or “a collaborative visual scene distance” in claims of the present disclosure.

In one or more embodiments, the image sequencer 145 may be configured for identifying the features and similarities of the objects present in the images. The image sequencer 145 may be configured for arranging and grouping the images having a similarity score higher than a threshold in a sequence, based on the relationship proximity distance between the images, and the features and the similarities of the objects present in the images. In one or more examples, a similarity score may be determined by comparing two different images. For example, a difference between each pixel in two images may be computed, where the cumulative sum of the differences is correlated to a similarity score. For example, the cumulative sum of differences between two identical images would be zero, which may be correlated with a high similarity score (e.g., 100). In contrast, the cumulative sum of differences between two images that are different from each other (e.g., a first image of a person playing football and a second image of a second person playing soccer) is high, which may be correlated with a low similarity score (e.g., 0).

In one or more embodiments, the bridge event predictor 146 may be configured for predicting the bridge event to connect the images based on the parameters associated with the images. For example, the bridge event predictor 146 may be configured for predicting the bridge event to connect the images based on the theme formed by the scene elements in the different images.

In one or more embodiments, the textual summarizer 147 may be configured to receive multiple images as the input and generate a textual summary of the multiple images capturing the most important elements, theme, setting, etc. Further, the textual summarizer 147 may create an understanding of how the image fits in to the story, to generate the graphical representation of the bridge event to connect the images.

The story management controller 140 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. In one or more examples, the story management controller 140 may be incorporated in the processor 120. For example, the processor 120 may execute one or more instructions in the memory 110 that causes the electronic device 100 to perform the operations of the story management controller 140.

In one or more examples, at least one of the plurality of modules/components of the drawing management controller 140 may be implemented through an AI model. A function associated with the AI model may be performed through memory 110 and the processor 120. The one or a plurality of processors controls the processing of the input data in accordance with a predefined operating rule or the AI model stored in the non-volatile memory and the volatile memory. The predefined operating rule or artificial intelligence model is provided through training or learning.

In one or more examples, being provided through learning means that, by applying a learning process to a plurality of learning data, a predefined operating rule or AI model of a desired characteristic is made. The learning may be performed in a device itself in which AI according to one or more embodiments is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

In one or more examples, the learning process is a method for training a predetermined target device (e.g., a robot) using a plurality of learning data to cause, allow, or control the target device to make a determination or prediction. Examples of learning processes include, but are not limited to, supervised learning, unsupervised learning, semi-supervised learning, or reinforcement learning. In one or more examples, an AI model may be trained on a training set of images such that the AI model is trained to identify scene elements, actions, and themes included in the images. In one or more examples, the AI model may be trained to generate a text summary. For example, a group of images with predefined scene elements, predefined actions, and predefined themes may be used as training data to train the AI model. Furthermore, the group of images may be associated with a predefined text summary that is compared with a text summary generated by the AI model to train the AI model.

In one or more embodiments, the display 150 may be configured for displaying the story comprising the first image, the second image, and the generated graphical representation between the first image and the second image for creating continuity in the story. The display 150 is implemented using touch sensitive technology and comprises one of liquid crystal display (LCD), light emitting diode (LED), etc.

Although the FIG. 1 shows the hardware elements of the electronic device 100, as understood by one of ordinary skill in the art, the embodiments are not limited to these configurations. In one or more embodiments, the electronic device 100 may include less or more number of elements. Further, the labels or names of the elements are used only for illustrative purpose and does not limit the scope of the embodiments of the present disclosure. One or more components can be combined together to perform same or substantially similar function.

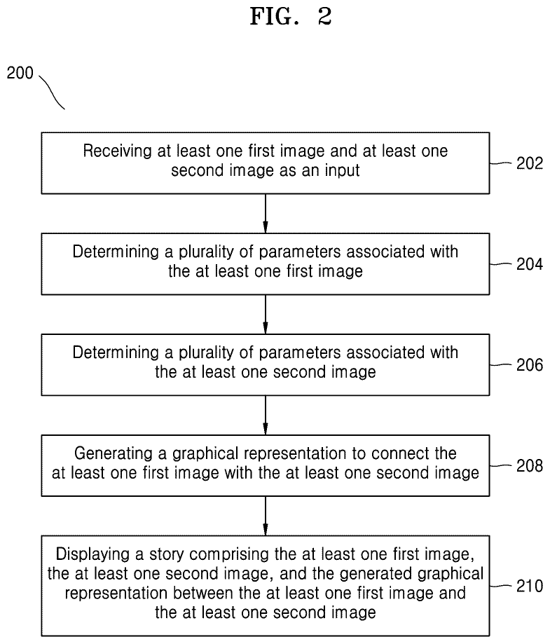

FIG. 2 is a flow chart (200) illustrating a method for creating continuity in the story by the electronic device 100, according to one or more embodiments.

Referring to the FIG. 2, at operation 202, the method includes the electronic device 100 receiving the first image and the second image as the input. For example, in the electronic device 100 as illustrated in the FIG. 1, the story management controller 140 may be configured to receive the first image and the second image as the input.

At operation 204, the method includes the electronic device 100 determining the plurality of parameters associated with the first image. The plurality of parameters associated with the first image includes determining scene elements in the first image, actions of the scene elements in the first image, and the theme formed by the scene elements in the first image. For example, in the electronic device 100 as illustrated in the FIG. 1, the story management controller 140 may be configured to determine the plurality of parameters associated with the first image.

At operation 206, the method includes the electronic device 100 determining the plurality of parameters associated with the second image. The plurality of parameters associated with the second image includes scene elements in the second image, actions of the scene elements in the second image, and the theme formed by the scene elements in the second image. For example, in the electronic device 100 as illustrated in the FIG. 1, the story management controller 140 may be configured to determine the plurality of parameters associated with the second image.

At operation 208, the method includes the electronic device 100 generating the graphical representation to connect the first image with the second image based on the plurality of parameters associated with the first image and the plurality of parameters associated with the second image. For example, in the electronic device 100, as illustrated in the FIG. 1, the story management controller 140 may be configured to generate the graphical representation to connect the first image with the second image based on the plurality of parameters associated with the first image and the plurality of parameters associated with the second image.

In one or more examples, the generated graphical representation may connect the first image with the second image. The graphical representation may be generated by: (i) predicting the bridge event that connects the first image with the second image based on the plurality of parameters associated with the first image and the plurality of parameters associated with the second image; and (ii) generating the graphical representation of the bridge event to connect the first image with the second image.

In one or more examples, the bridge event that connects the first image with the second image is predicted by: creating the textual summary for the first image and the second image based on the plurality of parameters associated with the first image and the plurality of parameters associated with the second image. Further, a first pictograph for the first image may be generated based on the textual summary created for the first image, and a second pictograph for the second image may be generated based on the textual summary created for the second image to predict the bridge event for connecting the first image and the second image.

In one or more examples, the graphical representation of the bridge event to connect the first image with the second image may be generated by: comparing the first image and the second image based on the theme formed by the scene elements in the first image and the theme formed by the scene elements in the second image, determining that an image relationship distance between the first image and the second image is less than a first threshold, and generating the graphical representation of the bridge event to connect the first image with the second image when the image relationship distance between the first image and the second image is less than the first threshold.

At operation 210, the method includes the electronic device 100 displaying the story comprising the first image, the second image, and the generated graphical representation between the first image and the second image. For example, in the electronic device 100, as illustrated in the FIG. 1, the story management controller 140 may be configured to display the story comprising the first image, the second image, and the generated graphical representation between the first image and the second image.

The various actions, acts, blocks, operations, or the like in the method may be performed in the order presented, in a different order or simultaneously. Further, in some embodiments, some of the actions, acts, blocks, operations, or the like may be omitted, added, modified, skipped, or the like without departing from the scope of the embodiments of the present disclosure.

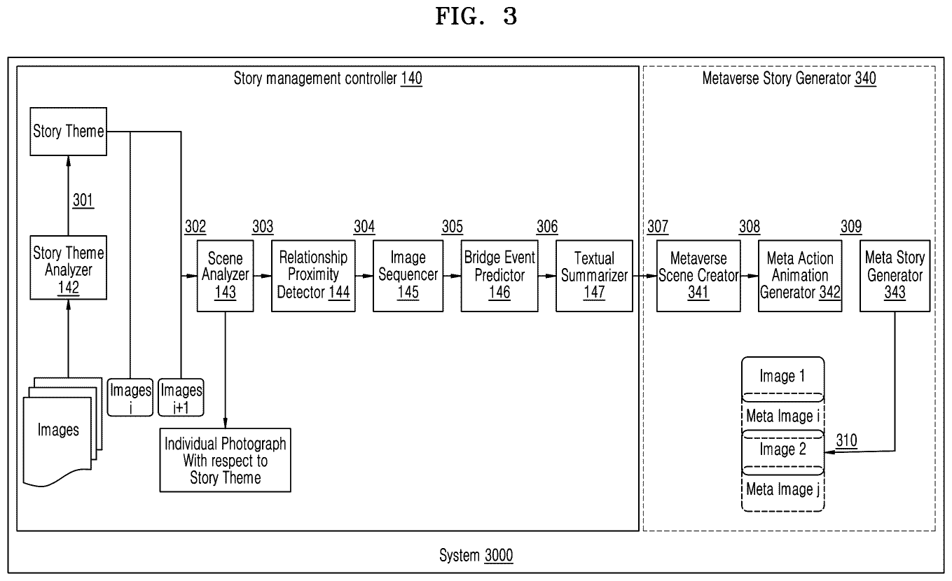

FIG. 3 is a block diagram of a system for creating continuity in the story, according to one or more embodiments.

Referring to FIG. 3, the system 3000 for creating continuity in the story may include the story management controller 140 and a metaverse story generator 340. In one or more examples, the metaverse story generator 340 may include a metaverse scene creator 341, a meta action animation generator 342 and a meta story generator 343. The metaverse story generator 340 may be included in the electronic device 100 or implemented externally to the electronic device 100.

At operation 301, the multiple images of the story are input into the story theme analyzer 142 of the story management controller 140. The story theme analyzer 142 analyzes the theme formed by the scene elements in the multiple images of the story. The story theme analyzer 142 summarizes the overall story including the multiple images into a detailed textual summary based on the theme of the story. The detailed textual summary is input into the scene analyzer 143.

At operation 302, the scene analyzer 143 receives the detailed textual summary of the overall story and predicts the scenes connecting one image with another image based on the parameters associated with the images. The scene analyzer 143 generates the pictograph for each image of the multiple images based on the textual summary of each image.

At operation 303, the relationship proximity distance between the consecutive images including the objects in the story is detected using the relationship proximity detector 144. In one or more examples, the relationship proximity detector 144 detects how far/near the images are related based on the theme formed by the scene elements in the multiple images of the story. The relationship proximity distance may refer to “an image relationship distance”, “a visual scene distance” or “a collaborative visual scene distance” in claims of the present disclosure.

At operation 304, the image sequencer 145 identifies the features and similarities of the objects present in the multiple images. The image sequencer 145 arranges and groups the images having the similarity score higher than the threshold in sequence, based on the relationship proximity distance between the images, and the features and the similarities of the objects present in the images.

At operation 305, the bridge event for connecting the consecutive images is predicted using the bridge event predictor 146, based on the theme formed by the scene elements in the different images.

At operation 306, the textual summarizer 147 receives multiple images as the input and generates the textual summary for each image of the multiple images capturing the most important elements, theme, setting, etc. Further, the textual summarizer 147 creates an understanding of how the image fits in to the story, to generate the graphical representation of the bridge event to connect the consecutive images of the story.

At operation 307, the metaverse scene creator 341 of the metaverse story generator 340 creates a metaverse scene based on the textual summary of each image of the multiple images received from the textual summarizer 147.

At operation 308, the meta action animation generator 342 generates the graphical representation of the bridge event to connect the consecutive images of the story. The graphical representation of the bridge event includes but not limited to a metaverse animation.

At operation 309, the meta story generator 343 generates continuity in the story by inserting the metaverse animation in between the consecutive images.

At operation 310, the story with the first image, the meta image and the second image will be displayed to enhance story viewing experience of the user in metaverse.

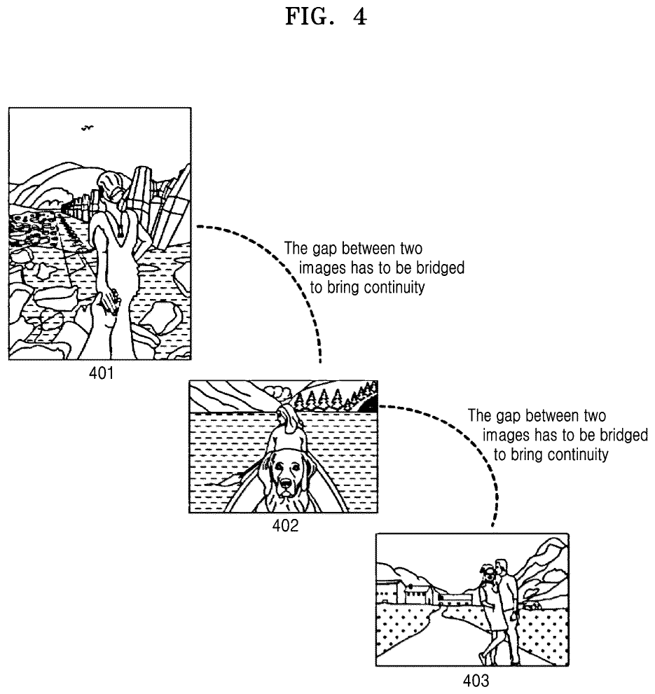

FIG. 4 is an example illustrating the images with gap to be bridged to bring continuity, according to the related art.

In general, a certain policy may be applied to a large set of images, where a group of photos is selected for automatic story creation. For example, the policy may specify select photos taken within a time period (e.g., photos taken during 2023). Further, in case of manual story creation, a collection of photos are grouped together to create the story. But in such cases, there still exists a gap between the consecutive photos in the story with respect to the action, the event, the characters, the scene, etc., and there is no continuity from one photo to another photo. Referring to FIG. 4, considering three images from the story, image 1 (401), image 2 (402) and image 3 (403), there is a gap between the image 1 (401) and the image 2 (402), and between the image 2 (402) and the image 3 (403). In the related art, the gap between the images is not bridged to bring continuity to the images in the story. Therefore, there is a need to bridge the gap between the images to bring in continuity to the images in the story, which is solved in the proposed method.

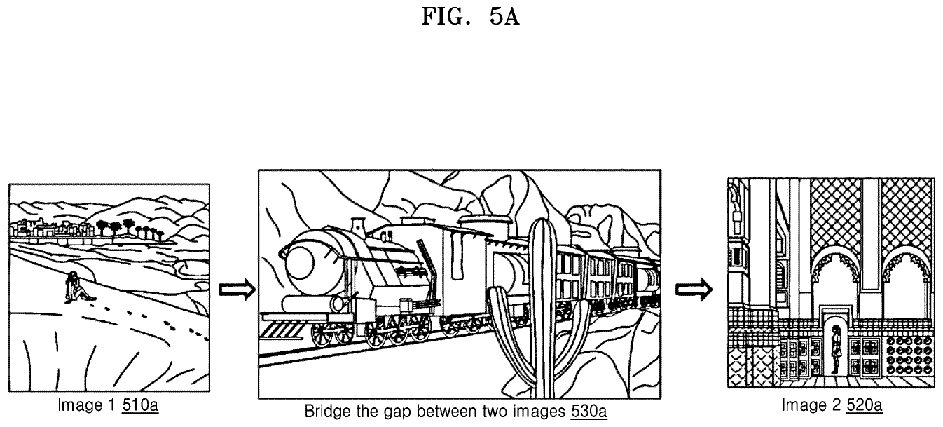

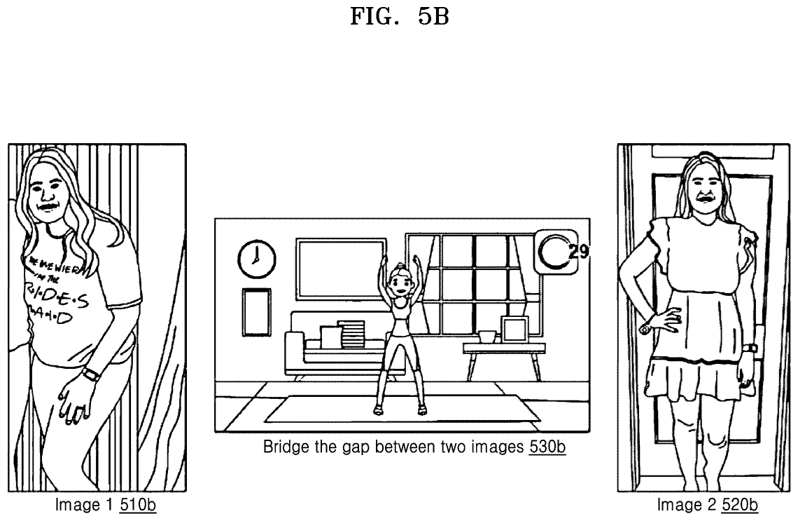

FIG. 5A and 5B are examples illustrating the process for bridging the gap between two images, according to one or more embodiments.

Referring to FIG. 5A and 5B, the image 1 (510a, 510b) and the image 2 (520a, 520b) are received as the input. The parameters associated with the image 1 (510a, 510b) and the image 2 (520a, 520b) are determined to predict the bridge event for connecting the image 1 (510a, 510b) with the image 2 (520a, 520b). For example, in image 510a, the determined parameters may be “landscape,” “person sitting,” etc., and in image 510b, the determined parameters may be “girl posing,” etc. In image 520a, the determined parameters may be “person standing in station,” and in image 520b, the determined parameters may be “person with reduced weight posing in clothes.” The bridge event is predicted based on the parameters associated with the image 1 (510a, 510b) and the image 2 (520a, 520b). The graphical representation (530a, 530b) of the bridge event may be generated to connect the image 1 (510a, 510b) with the image 2 (520a, 520b) to bridge the gap between the image 1 (510a, 510b) and the image 2 (520a, 520b). The graphical representation (530a, 530b) of the bridge event include but not limited to the metaverse animation. For example, in FIG. 5a, the graphical representation is an image of a train traveling, and in FIG. 5b, the graphical representation is an image of a person exercising.

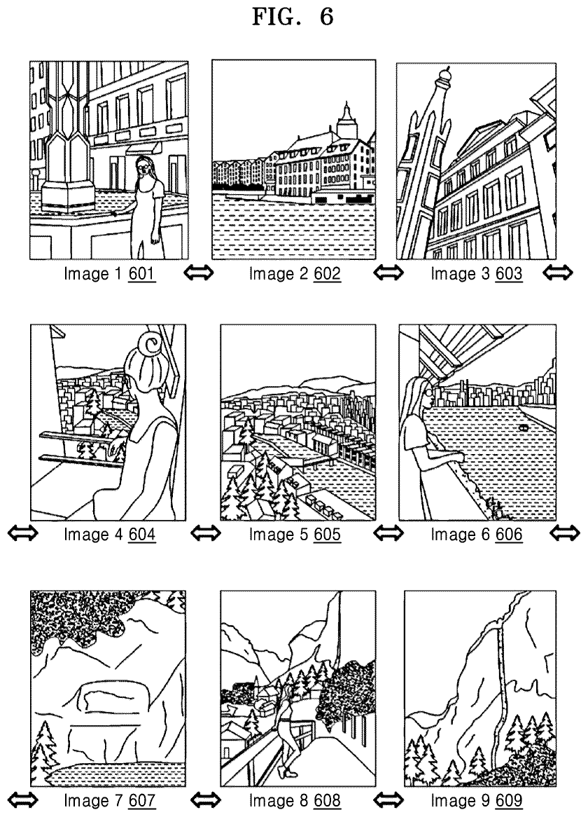

FIG. 6 is an example illustrating story visualization based on a scene distance, according to one or more embodiments.

Referring to FIG. 6, considering multiple images (601-609) from the story. The distance between the multiple images (601-609) in the story is different for different pair of images. For example, the distance between the image 4 (604) and the image 5 (605) is less when compared to the distance between the image 7 (607) and the image 8 (608). Therefore, the distance between the consecutive images of the story may be determined for generating the bridge event for connecting the consecutive images.

The multiple images (601-609) that have higher level of similarities are grouped into small sets. These sets are termed as a span in the story. In one or more examples, a story may contain multiple spans. In order to predict and generate metaverse animations, it is necessary to understand the spans of the story. A visual scene distance and/or a collaborative visual scene distance between the multiple spans of the multiple images (601-609) are determined based on the similarity score between the consecutive images such as for example the image 4 (604) and the image 5 (605) of the multiple images (601-609). The collaborative visual scene distance may refer to the visual scene distance. The graphical representation of the bridge event may be generated to connect the multiple spans of the multiple images (601-609) in the story when the visual scene distance and/or the collaborative visual scene distance between the multiple spans of the multiple images (601-609) is less than a second threshold.

In one or more embodiments, the electronic device 100 generate, multiple spans for the plurality of images based on the similarity score between the images of the plurality of images. The electronic device 100 determines, a trajectory of the object available in the plurality of images. The electronic device 100 identifies, the features of the object available in the plurality of images based on the determined trajectories of the objects available in the plurality of images. The electronic device 100 determines whether, the similarity score between the plurality of images is higher than a third threshold based on the identified features of the objects available in the plurality of images. The electronic device 100 generates, multiple spans for the plurality of images based on the similarity score between the plurality of images.

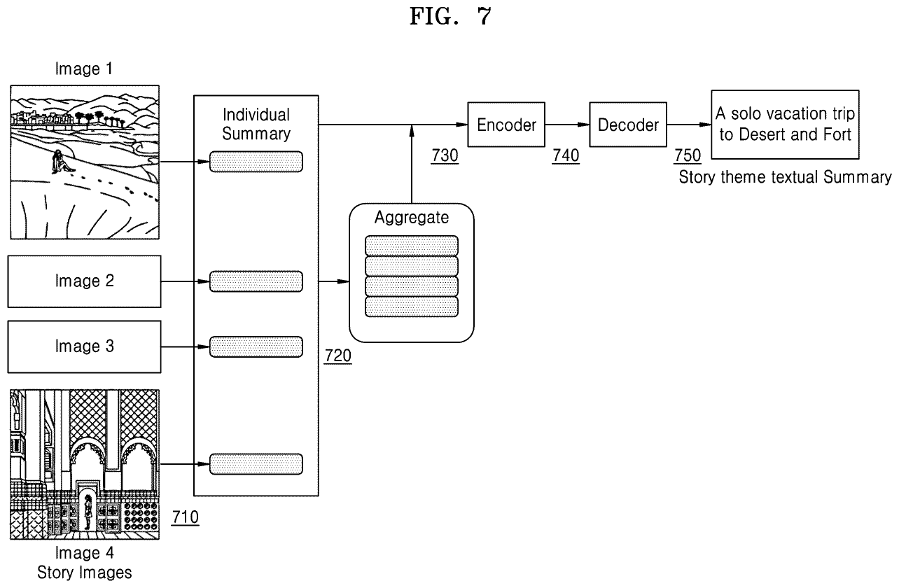

FIG. 7 is a block diagram illustrating multi-image story summarization, according to one or more embodiments.

In one or more embodiments, the story theme analyzer 142 is trained by taking multiple images as input and learning its properties and relationship. The story theme analyzer 142 takes multiple images in a story as input and generates a textual summary of the story capturing the most important elements, theme, setting, etc. In one or more embodiments, above training and inference operating can be done in the textual summarizer 147.

Referring to FIG. 7, at operation 710, image 1, image 2, image 3 and image 4 are selected from the story and each image is summarized into the textual summary.

At operation 720, the textual summary of each image is combined and summarized to an aggregate summary of the image 1, the image 2, the image 3 and the image 4.

At operation 730, an encoder may be configured for encoding and determining the most important elements, theme, setting, etc., from the image 1-image 4 and the aggregate summary of the image 1, the image 2, the image 3 and the image 4.

At operation 740, a decoder may be configured for converting the encoded digital stream into the textual summary of the image 1-image 4 of the story based on the most important elements, theme, setting, etc. of the images.

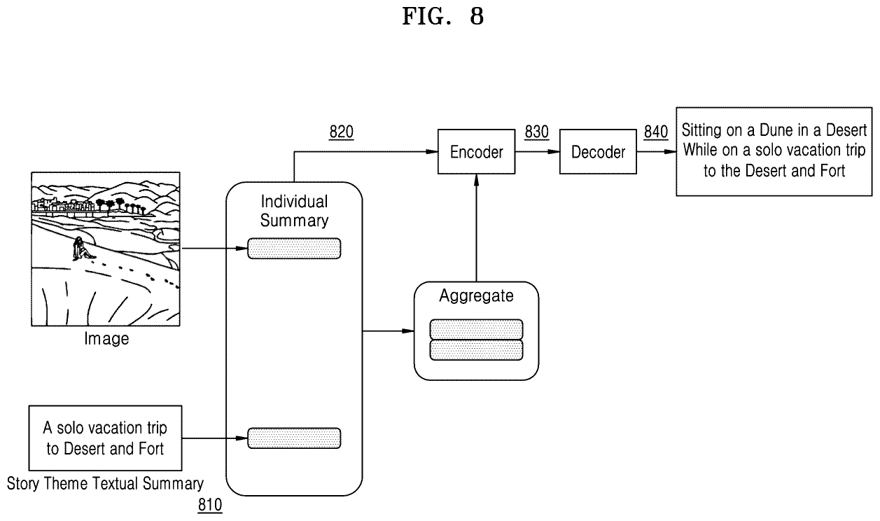

FIG. 8 is a block diagram illustrating the process of creating story based text summary for individual images, according to one or more embodiments.

In one or more embodiments, the textual summarizer 147 is trained based on the story theme formed by the scene elements of each image. The textual summarizer 147 takes an image and the textual summary of the story as input and learns its properties and relationship. The textual summarizer 147 takes images and the textual summary of the story as input and generates a textual summary of the image capturing the most important elements, theme, setting, etc. Further, the textual summarizer 147 captures how the image fits with the story.

Referring to FIG. 8, at operation 810, the image and the textual summary of the story output at operation 740 are received as input by the textual summarizer 147 and summarizes individually based on the elements, theme, settings, etc.

At operation 820, the individual summary of the image and the textual summary of the story output at operation 740 are combined to output the aggregate summary.

At operation 830, the individual summary of the image and the textual summary of the story, and the aggregate summary are encoded for determining the parameters associated with the images.

At operation 840, the decoder may be configured for decoding the encoded digital stream and outputting the textual summary for each image based on the parameters associated with the images.

Embodiments of the disclosure can also be embodied as a storage medium including instructions executable by a computer such as a program module executed by the computer. A computer readable medium can be any available medium which can be accessed by the computer and includes all volatile/non-volatile and removable/non-removable media.

Further, the computer readable medium may include all computer storage and communication media. The computer storage medium includes all volatile/non-volatile and removable/non-removable media embodied by a certain method or technology for storing information such as computer readable instruction code, a data structure, a program module or other data. Communication media may typically include computer readable instructions, data structures, or other data in a modulated data signal, such as program modules. In addition, computer-readable storage media may be provided in the form of non-transitory storage media.

The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to one or more embodiments of the disclosure, a method according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

The specific examples provided to explain the embodiments according to the present disclosure are merely a combination of each standard, method, detail method, and operation, and the various embodiments described herein can be performed through a combination of at least two or more techniques among the various techniques described. In addition, at this time, it can be performed according to a method determined through a combination of one or at least two or more of the aforementioned techniques. For example, it may be possible to perform a combination of parts of the operation of one embodiment with parts of the operation of another embodiment.

What is claimed is:

1. A method for creating continuity in digital content, the method comprising:
determining a plurality of parameters associated with at least one first image;
determining a plurality of parameters associated with at least one second image;
generating a graphical representation to connect the at least one first image with the at least one second image based on the plurality of parameters associated with the at least one first image and the plurality of parameters associated with the at least one second image; and
displaying the digital content comprising the at least one first image, the at least one second image, and the generated graphical representation between the at least one first image and the at least one second image.

2. The method of claim 1, wherein the plurality of parameters associated with the at least one first image comprises one or more scene elements in the at least one first image, one or more actions of the one or more scene elements in the at least one first image, and a theme formed by the one or more scene elements in the at least one first image, and
wherein the plurality of parameters associated with the at least one second image comprises one or more scene elements in the at least one second image, one or more actions of the one or more scene elements in the at least one second image, and a theme formed by the one or more scene elements in the at least one second image.

3. The method of claim 2, wherein the generating the graphical representation to connect the at least one first image with the at least one second image comprises:
predicting at least one bridge event that connects the at least one first image with the at least one second image based on the plurality of parameters associated with the at least one first image and the plurality of parameters associated with the at least one second image; and
generating a graphical representation of the bridge event to connect the at least one first image with the at least one second image.

4. The method of claim 3, wherein the predicting the at least one bridge event that connects the at least one first image with the at least one second image comprises:
creating a first textual summary for the at least one first image based on the plurality of parameters associated with the at least one first image;
creating a second textual summary for the at least one second image based on the plurality of parameters associated with the at least one second image;
generating, at least one first pictograph for the at least one first image based on the first textual summary created for the at least one first image;
generating at least one second pictograph for the at least one second image based on the second textual summary created for the at least one second image; and
predicting at least one bridge event for connecting the at least one first image and the at least one second image based on the at least one first pictograph generated for the at least one first image and the at least one second pictograph generated for the at least one second image.

5. The method of claim 3, wherein the generating the graphical representation of the bridge event to connect the at least one first image with the at least one second image comprises:
comparing the at least one first image and the at least one second image based on the theme formed by the one or more scene elements in the at least one first image and the theme formed by the one or more scene elements in the at least one second image;
identifying whether an image relationship distance between the at least one first image and the at least one second image is less than a first threshold based on the comparison between the at least one first image and the at least one second image; and
based on determining that the image relationship distance between the at least one first image and the at least one second image is less than the first threshold, generating the graphical representation of the bridge event to connect the at least one first image with the at least one second image.

6. The method of claim 1, the method further comprising:
obtaining a plurality of images that include the at least one first image and the at least one second image;
identifying one or more features of an object available in each image of the plurality of images;
determining a similarity score for grouping images of the plurality of images having features of the object with a different less than a threshold into a span;
generating multiple spans for the plurality of images based on the similarity score between the images of the plurality of images;
determining a visual scene distance between the multiple spans of the plurality of images;
determining whether the visual scene distance between the multiple spans of the plurality of images is less than a second threshold; and
based on determining that the visual scene distance between the multiple spans of the plurality of images is less than the second threshold, generating the graphical representation of the bridge event to connect the multiple spans of the plurality of images.

7. The method of claim 6, wherein the generating the multiple spans for the plurality of images based on the similarity score between the images of the plurality of images comprises:
determining a trajectory of the object available in the at least one first image of the plurality of images and the trajectory of the object available in the at least one second image of the plurality of images;
identifying the features of the object available in the at least one first image and the features of the object available in the at least one second image of the plurality of images based on the determined trajectories of the objects available in the at least one first image and in the at least one second image of the plurality of images;
determining whether the similarity score between the at least one first image of the plurality of images and the at least one second image of the plurality of images is higher than a third threshold based on the identified features of the objects available in the at least one first image and in the at least one second image of the plurality of images; and
generating the multiple spans for the plurality of images based on the similarity score between the at least one first image of the plurality of images and the at least one second image of the plurality of images.

8. An electronic device for creating continuity in digital content, the electronic device comprising:
memory storing one or more instructions;
communication circuitry;
a processor operatively coupled to the communication circuitry and the memory and configured to execute the one or more instructions in the memory,
wherein the one or more instructions, when executed by the processor, cause the electronic device to:
determine a plurality of parameters associated with a at least one first image,
determine a plurality of parameters associated with a at least one second image,
generate a graphical representation to connect the at least one first image with the at least one second image based on the plurality of parameters associated with the at least one first image and the plurality of parameters associated with the at least one second image, and
display the digital content comprising the at least one first image, the at least one second image, and the generated graphical representation between the at least one first image and the at least one second image.

9. The electronic device of claim 8, wherein the plurality of parameters associated with the at least one first image comprises one or more scene elements in the at least one first image, one or more actions of the one or more scene elements in the at least one first image, and a theme formed by the one or more scene elements in the at least one first image, and
wherein the plurality of parameters associated with the at least one second image comprises one or more scene elements in the at least one second image, one or more actions of the one or more scene elements in the at least one second image, and a theme formed by the one or more scene elements in the at least one second image.

10. The electronic device of claim 8, wherein the one or more instructions, when executed by the processor, cause the electronic device to:
predict at least one bridge event that connects the at least one first image with the at least one second image based on the plurality of parameters associated with the at least one first image and the plurality of parameters associated with the at least one second image, and
generate a graphical representation of the bridge event to connect the at least one first image with the at least one second image.

11. The electronic device of claim 10, wherein the one or more instructions, when executed by the processor, cause the electronic device to:
create a first textual summary for the at least one first image based on the plurality of parameters associated with the at least one first image,
create a second textual summary for the at least one second image based on the plurality of parameters associated with the at least one second image;
generate at least one first pictograph for the at least one first image based on the first textual summary created for the at least one first image;
generate at least one second pictograph for the at least one second image based on the second textual summary created for the at least one second image; and
predict at least one bridge event for connecting the at least one first image and the at least one second image based on the at least one first pictograph generated for the at least one first image and the at least one second pictograph generated for the at least one second image.

12. The electronic device of claim 10, wherein the one or more instructions, when executed by the processor, cause the electronic device to:
compare the at least one first image and the at least one second image based on the theme formed by the one or more scene elements in the at least one first image and the theme formed by the one or more scene elements in the at least one second image;
identify whether an image relationship distance between the at least one first image and the at least one second image is less than a first threshold based on the comparison between the at least one first image and the at least one second image; and
based on determining that the image relationship distance between the at least one first image and the at least one second image is less than the first threshold, generate the graphical representation of the bridge event to connect the at least one first image with the at least one second image.

13. The electronic device of claim 8, wherein the one or more instructions, when executed by the processor, cause the electronic device to:
obtain a plurality of images that include the at least one first image and the at least one second image;
identify one or more features of an object available in each image of the plurality of images;
determine a similarity score for grouping images of the plurality of images having features of the object with a different less than a threshold into a span;
generate multiple spans for the plurality of images based on the similarity score between the images of the plurality of images;
determine a visual scene distance between the multiple spans of the plurality of images;
determine whether the visual scene distance between the multiple spans of the plurality of images is less than a second threshold; and
based on determining that the visual scene distance between the multiple spans of the plurality of images is less than the second threshold, generate the graphical representation of the bridge event to connect the multiple spans of the plurality of images.

14. The electronic device of claim 13, wherein the one or more instructions, when executed by the processor, cause the electronic device to:
determine a trajectory of the object available in the at least one first image of the plurality of images and the trajectory of the object available in the at least one second image of the plurality of images;
identify the features of the object available in the at least one first image and the features of the object available in the at least one second image of the plurality of images based on the determined trajectories of the objects available in the at least one first image and in the at least one second image of the plurality of images;
determine the similarity score between the at least one first image of the plurality of images and the at least one second image of the plurality of images is higher than a third threshold based on the identified features of the objects available in the at least one first image and in the at least one second image of the plurality of images; and
generate the multiple spans for the plurality of images based on the similarity score between the at least one first image of the plurality of images and the at least one second image of the plurality of images.

15. A non-transitory computer readable medium having instructions stored therein, which when executed by a processor, cause the processor of an electronic device to perform a method for creating continuity in digital content, the method comprising:
determining a plurality of parameters associated with at least one first mage;
determining a plurality of parameters associated with at least one second image;
generating a graphical representation to connect the at least one first image with the at least one second image based on the plurality of parameters associated with the at least one first image and the plurality of parameters associated with the at least one second image; and
displaying the digital content comprising the at least one first image, the at least one second image, and the generated graphical representation between the at least one first image and the at least one second image.

16. The non-transitory computer readable medium according to claim 15, wherein the plurality of parameters associated with the at least one first image comprises one or more scene elements in the at least one first image, one or more actions of the one or more scene elements in the at least one first image, and a theme formed by the one or more scene elements in the at least one first image, and
wherein the plurality of parameters associated with the at least one second image comprises one or more scene elements in the at least one second image, one or more actions of the one or more scene elements in the at least one second image, and a theme formed by the one or more scene elements in the at least one second image.

17. The non-transitory computer readable medium according to claim 16, wherein the generating the graphical representation to connect the at least one first image with the at least one second image comprises:
predicting at least one bridge event that connects the at least one first image with the at least one second image based on the plurality of parameters associated with the at least one first image and the plurality of parameters associated with the at least one second image; and
generating a graphical representation of the bridge event to connect the at least one first image with the at least one second image.

18. The non-transitory computer readable medium of claim 17, wherein the predicting the at least one bridge event that connects the at least one first image with the at least one second image comprises:
creating a first textual summary for the at least one first image based on the plurality of parameters associated with the at least one first image;
creating a second textual summary for the at least one second image based on the plurality of parameters associated with the at least one second image;
generating, at least one first pictograph for the at least one first image based on the first textual summary created for the at least one first image;
generating at least one second pictograph for the at least one second image based on the second textual summary created for the at least one second image; and
predicting at least one bridge event for connecting the at least one first image and the at least one second image based on the at least one first pictograph generated for the at least one first image and the at least one second pictograph generated for the at least one second image.

19. The non-transitory computer readable medium of claim 17, wherein the generating the graphical representation of the bridge event to connect the at least one first image with the at least one second image comprises:
comparing the at least one first image and the at least one second image based on the theme formed by the one or more scene elements in the at least one first image and the theme formed by the one or more scene elements in the at least one second image;
identifying whether an image relationship distance between the at least one first image and the at least one second image is less than a first threshold based on the comparison between the at least one first image and the at least one second image; and
based on determining that the image relationship distance between the at least one first image and the at least one second image is less than the first threshold, generating the graphical representation of the bridge event to connect the at least one first image with the at least one second image.

20. The non-transitory computer readable medium of claim 15, wherein the method further comprises:
obtaining a plurality of images that include the at least one first image and the at least one second image;
identifying one or more features of an object available in each image of the plurality of images;
determining a similarity score for grouping images of the plurality of images having features of the object with a different less than a threshold into a span;
generating multiple spans for the plurality of images based on the similarity score between the images of the plurality of images;
determining a visual scene distance between the multiple spans of the plurality of images;
determining whether the visual scene distance between the multiple spans of the plurality of images is less than a second threshold; and
based on determining that the visual scene distance between the multiple spans of the plurality of images is less than the second threshold, generating the graphical representation of the bridge event to connect the multiple spans of the plurality of images.
